(19) United States
(12) Patent Application Publication
(10) Pub. No.: US 2019/0079965 A1
(43) Pub. Date: Mar. 14, 2019

(54) APPARATUS AND METHOD FOR REAL TIME ANALYSIS, PREDICTING AND REPORTING OF ANOMALOUS DATABASE TRANSACTION LOG ACTIVITY

(71) Applicant: Striim, Inc., Palo Alto, CA (US)

(72) Inventors: Alok PAREEK, Hillsborough, CA (US); Rajkumar SEN, San Mateo, CA (US); Bhushan KHALADKAR, Palo Alto, CA (US); Ali KUTAY, Palo Alto, CA (US); Changsha MA, Palo Alto, CA (US)

(21) Appl. No.: 16/123,515

(22) Filed: Sep. 6, 2018

Related U.S. Application Data
(60) Provisional application No. 62/556,176, filed on Sep. 8, 2017.

(51) Int. Cl. G06F 17/30

(52) U.S. Cl. CPC G06F 17/30368; G06F 17/30227; G06F 17/30371

(57) ABSTRACT

An apparatus has a processor and random access memory connected to the processor. The random access memory stores instructions executed by the processor to capture database transaction data from a database transaction log. Transaction log aggregated information that augments the database transaction data into a format that does not exist in the database transaction log is formed. The format includes a new transaction log parameter added to an existing transaction log parameter. An anomaly report is issued in response to a discrepancy between the transaction log aggregated information and a model of normative database transaction log activity. The transaction log aggregated information is written to persistent memory after the issue of the anomaly report.

### CROSS-REFERENCE TO RELATED APPLICATION

This application claims priority to U.S. Provisional Patent Application Ser. No. 62/556,176, filed Sep. 8, 2017, the contents of which are incorporated herein by reference.

### FIELD OF THE INVENTION

This invention relates generally to computer databases. More particularly, this invention is directed toward real time processing of database transaction log information for the purposes of detecting, alerting, predicting and visualizing transactional, user, system and operational anomalies.

### BACKGROUND OF THE INVENTION

A database transaction log is a file that lists changes to a database. A database transaction log is also referred to as a transaction log, transaction journal, database log, binary log or audit trail. Such a log is persistently stored and is used to reconstruct a database in the event of a database problem. For example, if the database is in an inconsistent state or is improperly shut down, the database management system reviews the database transaction log for uncommitted transactions and rolls back the changes made by these transactions. In addition, transactions that are committed, but whose changes were not yet materialized in the database are re-applied. Thus, a database transaction log supports the atomicity, consistency, isolation and durability (ACID) of a database.

Database transaction logs are highly valued for their role in maintaining database integrity. These logs have also been historically used for database replication and integration by reading the changes and applying them to a secondary database copy—for providing database high availability or operational copies for test systems, etc. In addition to the important role of the transaction log in these uses cases, it is desirable to further leverage the information in database transaction logs for additional purposes.

### SUMMARY OF THE INVENTION

An apparatus has a processor and random access memory connected to the processor. The random access memory stores instructions executed by the processor to capture database transaction data from a database transaction log. Transaction log aggregated information that augments the database transaction data into a format that does not exist in the database transaction log is formed. The format includes a new transaction log parameter added to an existing transaction log parameter. An anomaly report is continually issued in response to a discrepancy between the transaction log aggregated information and a predictive model of normative database transaction log activity. The transaction log aggregated information is written to persistent memory after the issue of the anomaly report.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

FIG. 3 illustrates an anomaly identified in accordance with an embodiment of the invention.

FIG. 4 illustrates a report produced in accordance with an embodiment of the invention.

Like reference numerals refer to corresponding parts throughout the several views of the drawings.

### DETAILED DESCRIPTION OF THE INVENTION

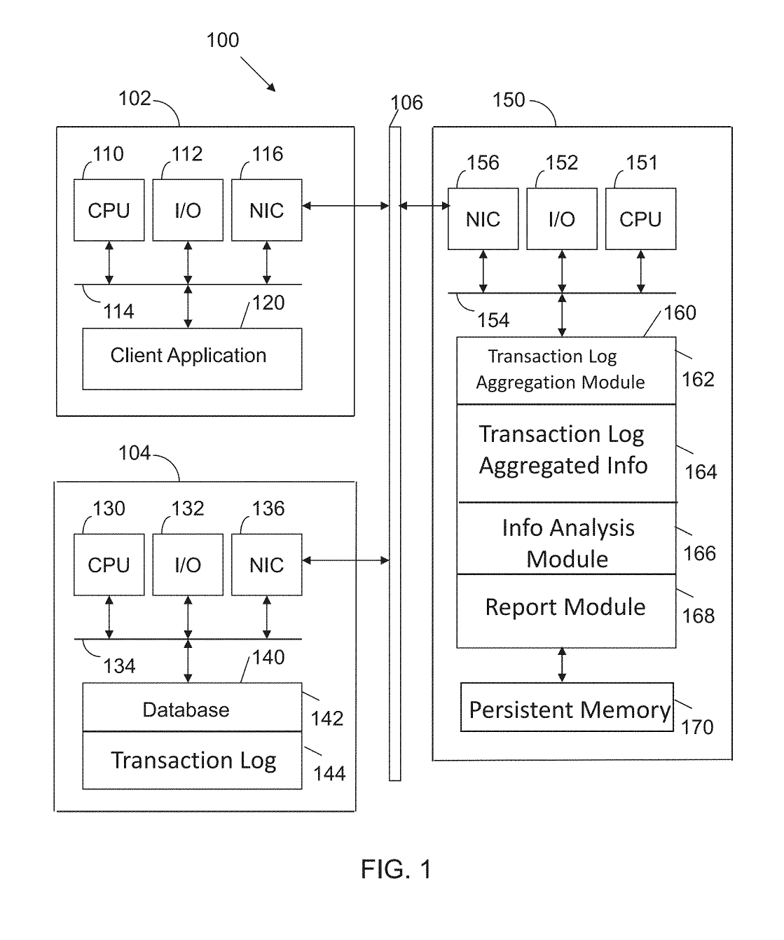

FIG. 1 illustrates a system with a client machine 102 connected to a server 104 via a network 106, which may be any combination of wired and wireless networks. The client machine 102 includes a processor (e.g., a central processing unit) 110 and input/output devices 112 connected via a bus 114. The input/output devices 112 may include a keyboard, mouse, touch display and the like. A network interface circuit 116 is also connected to the bus 114 to provide connectivity to network 106. A memory 120 is also connected to the bus 114. The memory 120 stores a client application 122 that is used to access server 104 and receive information from server 104, such as information related to database activity. The client application also accesses server 150 to obtain transaction log aggregated information, reports on information anomalies and the like, as detailed below. The client machine 102 may be a computer, tablet, mobile device, wearable device and the like.

Server 104 includes a processor 130, input/output devices 132, a bus 134 and a network interface circuit 136. A memory 140 is also connected to the bus 134. The memory 140 stores instructions executed by the processor 130 to implement operations disclosed herein. The memory 140 stores a database 142, such as a relational database or a database of semi-structured data. The database 142 has an associated transaction log 144. The database transaction log 144 lists changes that transpire within database 142. Each change may be characterized by any number of transaction log parameters, such as a table name, a log sequence number, a transaction identification and a transaction operation. Exemplary transaction operations include update, insert, delete, commit, update and redo. Each change may be further characterized by a transaction name, context information, a page identification, a begin time and an end time. Each change may also specify a user and a session. The information in the transaction log 144 is persistently stored.

It is known in the art to analyze the persistently stored data in the transaction log 144 with respect to various metrics and measures. This is typically done asynchronously in an offline session.

The database 142 can also be configured to write the database transaction data to network 106, where it is collected by server 150. The operations of server 150 may be incorporated into server 104, but the invention is disclosed in the context of an embodiment where server 150 is independently operative to supply real time analytics based upon database transaction data. Observe that in this embodiment the real time analytics are provided outside the operation of the database 142. Consequently, the processing associated with the invention does not tax the database 142. Typical database analyses are performed based upon different snapshots of the database. Such an approach is computationally expensive and otherwise degrades the performance of the database 142.

The server 150 includes a processor, 151, input/output devices 152, a bus 154 and a network interface circuit 156. A memory 160 stores instructions to implement operations disclosed herein. The memory 160 is a random access memory that continuously processes database transaction data to provide real time reports before the database transaction data is stored in persistent memory 170. Thus, unlike the prior art, which asynchronously analyzes transaction log data in offline sessions to provide historic information, the present invention provides real time information at or about the time (e.g., within one second) that the database transaction data is created. The invention also provides predictions on database transaction activity based on machine learning models. Server 150 may be one of a set of similarly configured servers used to support, in parallel, the operations disclosed herein.

The memory 160 stores a transaction log aggregation module 162. The transaction log aggregation module 162 includes instructions executed by processor 151 to form transaction log aggregated information 164. More particularly, the transaction log aggregation module 162 enriches the database transaction log information with additional information, such that it is in a format that does not exist in the database transaction log. The format uses a parameter to combine information related to the parameter. The parameter may be any parameter associated with the transaction log. For example, the parameter may be a table, user and/or a session. The parameter may be used form an additional parameter. For example, the additional parameter may be aggregate information over time. Different time periods may be specified, such as 5 minutes, 15 minutes, 30 minutes, 1 hour, etc. For each time period, information may be collected about a particular activity. For example, the activity may be the activity of a user or activity associated with a particular table in the database 142. Each time period may be supplemented with additional data, such as a minimum, a maximum, an average, a mean, etc. Thus, time periods and supplemental data are examples of transaction log aggregated information that augments database transaction data into a format that does not exist in the database transaction log. The format includes a new transaction log parameter added to an existing transaction log parameter.

Observe that the transaction log aggregation module 162 processes information in the transaction log 144 to produce transaction log aggregated information 164 that may be used to evaluate database activity. Thus, the utility of the transaction log 144 is no longer limited to database integrity issues.

An information analysis module 166 may be used to analyze the transaction log aggregated information 164. In one embodiment, the information analysis module 166 includes machine learning modules that evaluate database activity. For example, the information analysis module 166 may evaluate user and/or session information for a specified period of time. The information analysis module 166 may assess whether the transactional activity is normal, such as whether the order of accessing tables is normal. Other activities that may be tracked over time may be the number of operations, the login time, the session duration, and the like. The machine learning modules may implement time-series forecasting, regression analyses, predictive alerting, nearest/farthest-neighbor analyses and/or hyper-parameter optimization.

The information analysis module 166 may evaluate transaction log aggregated information 164 by table name for different specified periods of time. A time dimension may be used to track any number of database activity parameters, such as number of users, redo rates, operations rates, commit rates, rollback rates, redo bytes, and the like.

The information analysis module 166 identifies a discrepancy between transaction log aggregated information and a model of normative database transaction log activity. The model of normative database transaction log activity may be based upon the various factors discussed above, including a time window, a database user, database session historical data, database table historical change data, and database transaction historical data. The model of normative database transaction log activity may be a predictive model. In such a case the anomaly report is predicting an event prior to it transpiring. The model of normative database transaction log activity may be based upon actual data within the database 142 and/or metadata associated with the database 142.

It should be appreciated that the models of normative database transaction log activity are based upon transactional data. While it is known in the prior art to analyze error logs associated with a transaction log, the prior art does not contemplate the analysis of transactional data to identify or predict in real time a potential database problem.

The memory 160 may also store a report module 168. The report module 168 supplies information from the information analysis module 166 to the client machine 102. More particularly, the report module 168 includes instructions executed by the processor 150 to issue an anomaly report in response to a discrepancy between the transaction log aggregated information and a model of normative database transaction log activity, as identified by the information analysis module 166. The report module 168 then writes the recently received transaction log aggregated information to persistent memory 170 after the issue of the anomaly report. The persistent memory 170 stores the models of normative database transaction log activity. As new transaction log aggregated information is written to persistent memory 170, the information analysis module 166 updates one or more models.

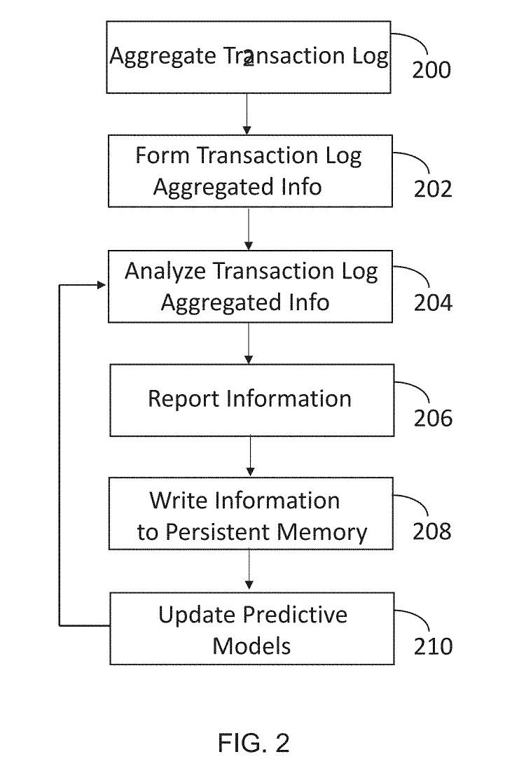

FIG. 2 illustrates processing operations associated with an embodiment of the invention. Transaction log aggregated information is formed 200. For example, transaction log aggregation module 162 augments the database transaction data into a format that does not exist in the database transaction log, such as adding a new transaction log parameter to an existing transaction log parameter. In this way, transaction log aggregated information is formed 202. The transaction log aggregated information is then analyzed 204, for instance by the information analysis module 150. This is performed in real time immediately after the capture of the database transaction data and the formation of the transaction log aggregated information. Information is then reported in real time 206. For example, the report module 168 may report information to client machine 102. The reports may include a statistical overview, abnormal database activities, and/or forecasted database activity. The reports may be in the form of a live dashboard of current database activity, emails, messages, etc. Additionally, the reports may include model performance, data evolution, and model updates. The reports may trigger a model update based upon pre-selected rules.

The recently received information is then written to persistent memory 208. One or more predictive models is updated 210 based upon the new information. The information analysis module 166 may be used for this purpose.

Thus, the invention provides real time information based upon newly generated transaction log information. By evaluating transactional data in real time, the system provides a database administrator with a lens into the operation of the system and potential problems. In addition to the real time component, the invention provides model building and model refining based upon processing of data stored in persistent memory.

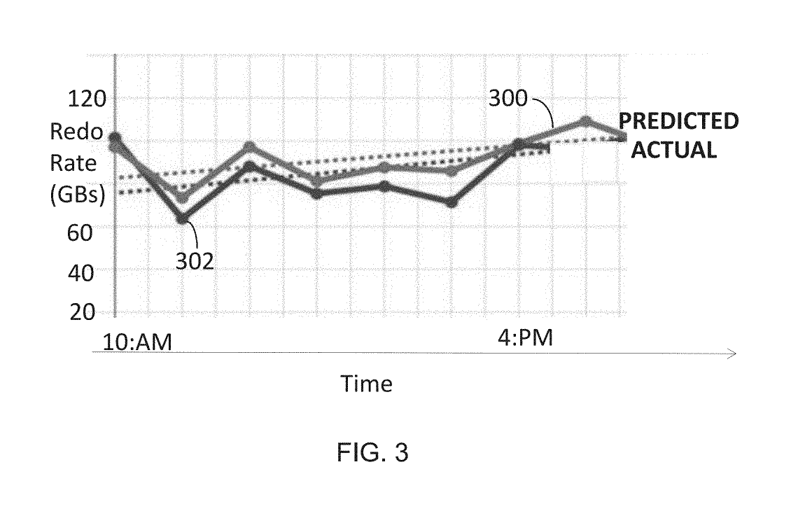

FIG. 3 is an example of information that may be reported. FIG. 3 illustrates a redo rate as a function of time. Based upon prior database activity, information analysis module 150 may have a model of a predicted redo rate over time 300. An actual redo rate over time 302 may also be tracked. A discrepancy between the predicted activity and the actual activity may be reported as an anomaly. The information in FIG. 3 may be presented to a user at client machine 102. Alternately, the information may be evaluated at server 104 or server 150 and a report may be sent to client machine 102 in the case that anomalous behavior exceeds a preconfigured threshold.

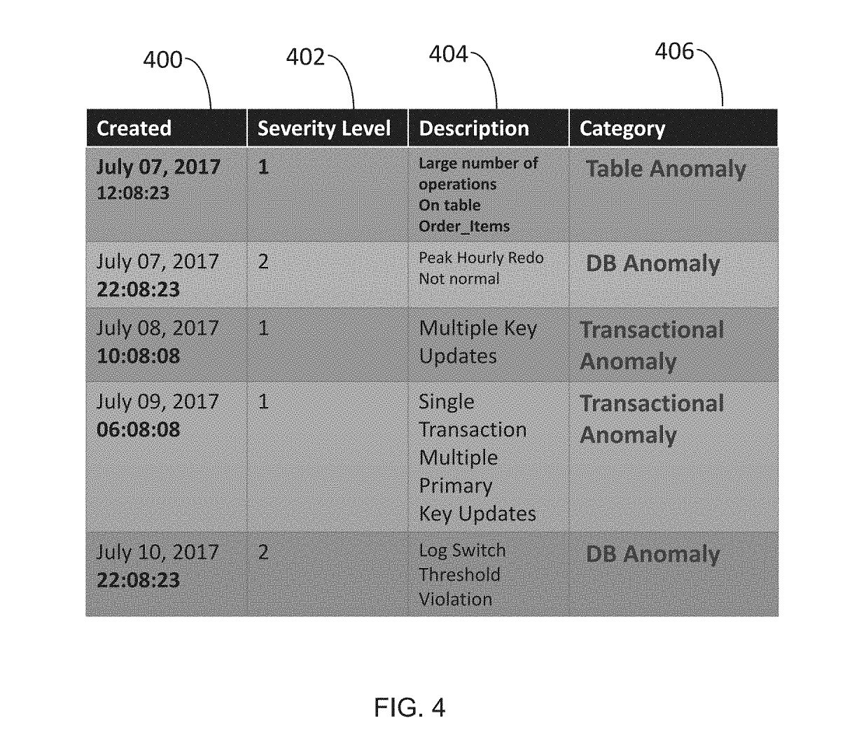

FIG. 4 provides an example of a report that may be formed in accordance with an embodiment of the invention. The report includes a column 400 with a time stamp. Another column 402 specifies a severity level associated with the event. Column 404 provides a description of the event, while column 406 ascribes a category to an event.

Thus, the invention provides a capability to provide analytics on database transaction logs. Any number of database logs may be accessed. Transaction log aggregated information may include time series aggregates on various parameters associated with transaction log information. The information analysis module 166 may incorporate machine learning tools to provide various visualizations and reports.

The transaction log aggregated information 164 may include database metadata, such as table name, log sequence number, transaction identification, etc. Thus, there is an ability to evaluate and report database metadata activity. The transaction log aggregated information 164 may also include actual data from the database. The data may be discrete database cell values. The data may also be augmented data values, such as a minimum value, a maximum value, an average value and a mean value associated with a database table. Thus, the invention provides the ability to perform data analyses based upon a transaction log. Such analyses may include searches and predictions. For example, the prediction may relate to the need for additional database memory. Alternately, the prediction may relate to operational efficiencies associated with the database.

Thus, artificial intelligence methods involving machine learning techniques are used on the contents of transaction logs to build patterns on transactional data. The patterns are used to detect, alert, predict and visualize anomalies of various types, such as user behavior deviation, transactional/operational behavior deviation, system behavior deviation and the like

The advantages of the invention are more fully appreciated in connection with the following discussion of specific embodiments. Transaction log aggregated information is processed using models of normative database transaction log activity. The models of normative database transaction log activity are trained from historical transaction log aggregated information. For example, the seasonal time series of database operations may be de-seasonalized using a seasonality detection model that is updated every hour. A time series of pre-processed transaction log aggregated information is then used to forecast future transaction log aggregated information with a forecasting model trained/retrained from recent historical data. For example, an autoregressive integrated moving average (arima) model can be fitted on the recent database operation time series and served for forecasting the future database operation time series. Other regression models such as a Gaussian regression model or Support Vector Machine (SVM) regression model may also be trained on the recent transaction log aggregated information and served for forecasting. Users can choose from a set of available models. The forecast results may be reported and further analyzed. For example, the forecast results can be leveraged to guide predictive database management and resource planning. The forecasted values can be stored in persistent memory 170 and be compared with observed real values over a period of time to measure model performance and to further update the models. The persistent memory 170 stores the models and historical transaction log aggregated information. The transaction log aggregated information 164 in random access memory 160 is real time data that is compared to the models using the information analysis module 166.

In one embodiment, the information analysis module 166 uses an anomaly detection model based on the discrepancy of a predicted value and an observed value. For example, if the observed value of the Data Manipulation Language (DML) operation number is much higher or lower than its predicted value, this data point is an anomaly. More sophisticated anomaly detection models can be applied to improve algorithm robustness and reduce false positives. For example, an anomaly score is first calculated according to the discrepancy of the predicted value and the observed value. Furthermore, a spike detection is applied on the time series of anomaly scores. A spike indicates a single point anomaly. A high frequency of anomalies may indicate bad performance of the forecast model and trigger retraining of the forecast model.

An embodiment of the invention identifies abnormal patterns. Transaction log aggregated information is processed using a time series processing algorithm. For example, the time series of transactions with trend may be de-trended using online time series differencing. A time series of pre-processed transaction log aggregated information is then used to create the features as input to an abnormal pattern detection model. For example, a one-day de-trended time series of transaction numbers is segmented into twelve transaction time series subsequences and the mean and variance of each subsequence of transaction numbers are used as features. These features are input to a model trained or retrained from observed patterns for abnormal pattern detection. For example, a one-class SVM model can be trained on normal patterns and used to report issues on unseen patterns. Other anomaly detection models such as auto-encoder may also be used. The detected abnormal pattern may be reported. The detection results can be further analyzed. For example, a high frequency of abnormal patterns may indicate unseen patterns appearing and the abnormal pattern detection model should be retrained with new patterns. Another example is tracing down the root causes of an anomaly.

Historical transaction log data from persistent memory may be ingested into information analysis module 166 and parsed into a data stream with specific data fields. For example, a data stream of a transaction log may contain table name field, user name field, DML type field, timestamp field, commit field, etc. A continuous query (CQ) mechanism associated with the information analysis module 166 filters and cleans the data stream of transaction log information and forms a data stream of filtered transaction log information. For example, the CQ mechanism may select transaction information related to a specific user, or may remove transaction information without complete fields. A jumping window mechanism associated with the information analysis module 166 aggregates transaction log information over a period of event time, e.g., one minute, and forms a data stream of transaction log aggregated information. The jumping window mechanism may partition a stream of filtered transaction log data by parameters, such as DML type. In this way, transaction log information may be aggregated based on the partition window parameters.

Transaction log aggregated information from persistent memory 170 may be ingested into the information analysis module 166. An event table stores the seasonality information of the transaction log aggregated information. For example, the number of database operations reaches its peak around 1:00 PM every day, and the average peak value is about 1000 per minute. The CQ mechanism maps the timestamp of the transaction log aggregated information stream to a seasonality index, which is the key of seasonality event tables. The CQ mechanism searches for seasonality values in event table using a seasonality index, and extracts a seasonality value from an observed value. In this way, a data stream of deseasonalized transaction log aggregated information is formed. A sliding window mechanism aggregates data streams of deseasonalized transaction log aggregated information over a period of time, e.g. two hours, and forms a list of data streams as the training data. The CQ mechanism trains a forecast model using the training data. The forecast model may be from external libraries, frameworks, or platforms. For example, the CQ mechanism may utilize an auto.arima( ) function to fit an arima model on training data. A trained model may be saved for use with new data streams. For example, the model can be saved as a form of file and stored in the local file system. The training process may be triggered periodically to update the forecast model and the period is the slide step of the sliding window. The sliding window aggregates data streams of deseasonalized transaction log aggregated information over a period of time, e.g., 10 minutes, and forms a list of data streams as predictors. The CQ mechanism performs forecast on the predictors using a forecast model trained by the CQ mechanism. The forecast process is triggered per receiving each new observation of transaction log aggregated information. The timestamps associated with the forecast results may be mapped to seasonality indexes and be used to add back seasonality values from a seasonality event table. The final forecast results may be stored in persistent memory 170 and be reported to users. The report may be the observed values of transaction log aggregated information over a past period of time with forecasted values over a future period of time, e.g., the number of database operations in the past two hours and its forecast for the next hour.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
a processor; and
a random access memory connected to the processor, the random access memory storing instructions executed by the processor to:
capture database transaction data from a database transaction log,
form transaction log aggregated information that augments the database transaction data into a format that does not exist in the database transaction log, where the format includes a new transaction log parameter added to an existing transaction log parameter,
issue an anomaly report in response to a discrepancy between the transaction log aggregated information and a model of normative database transaction log activity, and
write the transaction log aggregated information to persistent memory after the issue of the anomaly report.

2. The apparatus of claim 1 wherein the model of normative database transaction log activity is based upon a time window.

3. The apparatus of claim 1 wherein the model of normative database transaction log activity is based upon a database user.

4. The apparatus of claim 1 wherein the model of normative database transaction log activity is based upon database session historical data.

5. The apparatus of claim 1 wherein the model of normative database transaction log activity is based upon database table historical change data.

6. The apparatus of claim 1 wherein the model of normative database transaction log activity is based upon database transaction historical data.

7. The apparatus of claim 1 wherein the model of normative database transaction log activity is a predictive model.

8. The apparatus of claim 1 wherein the transaction log aggregated information includes database metadata.

9. The apparatus of claim 1 wherein the transaction log aggregated information includes data from the database transaction log.

10. The apparatus of claim 1 further comprising instructions executed by the processor to revise the model of normative database transaction log activity based upon the transaction log aggregated information.
